(19) United States
(12) Patent Application Publication
(10) Pub. No.: US 2013/0290478 A1
(43) Pub. Date: Oct. 31, 2013

(54) SYSTEM AND METHOD FOR ENABLING A REMOTE COMPUTER TO CONNECT TO A PRIMARY COMPUTER FOR REMOTE GRAPHICS

(71) Applicant: Franck DIARD, Saint-Contest (FR)

(72) Inventor: Franck DIARD, Saint-Contest (FR)

(21) Appl. No.: 13/460,729

(22) Filed: Apr. 30, 2012

(51) Int. Cl. G06F 15/16

(52) U.S. Cl. 709/217

(57) ABSTRACT

One embodiment of the present invention sets forth a method for enabling a remote computer to receive graphics data from a primary computer. An external storage device is populated with remote graphics client software and connection information. The external storage device is then connected to a remote computer from which the user would like to connect to the primary computer. The remote graphics client software executes on the remote computer without any installation and configuration operations. The primary computer subsequently receives a connection request from the remote graphics client software executing on the remote computer. In response to the connection request, the primary computer transmits locally rendered graphics data to the remote computer for display on a display device coupled to the remote computer.

### BACKGROUND OF THE INVENTION

1. Field of the Invention

The present invention relates generally to remote access, and, more specifically, to a system and method for enabling a remote computer to connect to a primary computer for remote graphics.

2. Description of the Related Art

Desktop sharing technologies enable the remote access of a primary computer via graphical terminal that executes on a secondary computer. The graphical terminal allows a user of the secondary computer to view and access any applications executing on the primary computer. To enable the operations of the graphics terminal, a server software typically executes on the primary computer that collects graphics data related to applications executing on the primary computer. A client software executing on the secondary computer then receives the collected graphics data for display to a user.

One drawback of current desktop sharing solutions is that several setup and application installation operations need to be conducted by a user at the secondary computer before the secondary computer can receive graphics data from the primary computer. Such setup and installation operations are cumbersome for the user, thereby reducing the overall quality of the user experience. Further, because current desktop sharing solutions require the user to install one or more applications on the secondary computer, a user cannot connect to the primary computer from a secondary computer on which the user does not have the authority to install applications.

As the foregoing illustrates, what is needed in the art is a mechanism for enabling a remote computer to connect to a primary computer more efficiently.

### SUMMARY OF THE INVENTION

One embodiment of the present invention sets forth a method for enabling a remote computer to receive graphics data from a primary computer. The method includes the steps of populating an external storage device with remote graphics client software and receiving a connection request from the remote graphics client software when the remote graphics client software is executing on a secondary computing device that is coupled to the external storage device. The method further includes the step of, in response to the connection request, transmitting locally rendered graphics data to the secondary computing device.

Advantageously, the remote graphics client software stored on the external storage device executes directly on the remote computer without any installation and configuration operations. Therefore, the remote graphics client software is able to connect to a server process efficiently and quickly without requiring any manual user operations.

### BRIEF DESCRIPTION OF THE DRAWINGS

So that the manner in which the above recited features of the present invention can be understood in detail, a more particular description of the invention, briefly summarized above, may be had by reference to embodiments, some of which are illustrated in the appended drawings. It is to be noted, however, that the appended drawings illustrate only typical embodiments of this invention and are therefore not to be considered limiting of its scope, for the invention may admit to other equally effective embodiments.

FIG. 1 illustrates a remote computing environment, according to one embodiment of the invention;

FIG. 2 illustrates a more detailed view of the primary computer of FIG. 1, according to one embodiment of the present invention;

FIG. 3 is a more detailed view of the server software of FIG. 1, according to one embodiment of the present invention;

FIG. 4 illustrates a technique that enables the transmission of rendered graphics data to the client software, according to one embodiment of the invention; and

FIG. 5 is a flow diagram of method steps for enabling a client machine to connect to the remote server using data stored on a USB drive, according to one embodiment of the invention.

### DETAILED DESCRIPTION

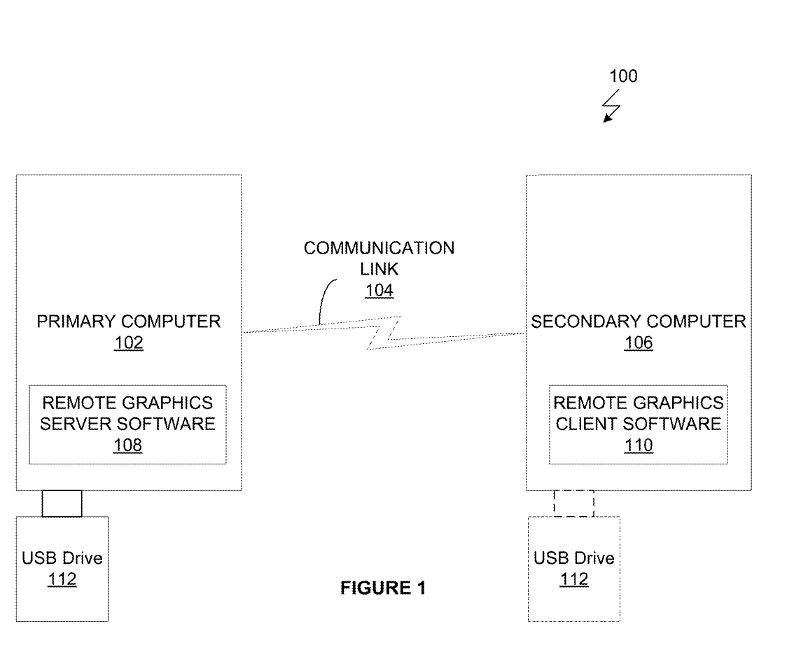

FIG. 1 illustrates a remote computing environment 100, according to one embodiment of the invention. As shown, the remote computing environment 100 includes a primary computer 102, a secondary computer 106 and a communications link 104.

The secondary computer 106 includes a remote graphics client software 110 (referred to herein as the “client software 110”) that communicates with a remote graphics server software 108 (referred to herein as the “server software 108”) included in the primary computer 102 via the communications link 104. The client software 110 allows a user to remotely connect to the primary computer 102 such that any graphics that is rendered and displayed on the primary computer 102 is transmitted to and displayed on the secondary computer 106.

As explained in greater detail below, in one embodiment, a universal serial bus (USB) drive 112 is first coupled to the primary computer 102. When the USB drive 112 is coupled to the primary computer 102, the USB drive 112 is populated with the client software 110 and other necessary information. The USB drive 112 is then coupled to the secondary computer 106. When the USB drive 112 is coupled to the secondary computer 106, the client software 110 and other necessary information on the USB drive 112 are used to connect from the secondary computer 106 to the server software 108 executing on the primary computer 102.

In operation, the server software 108, when initialized on the primary computer 102, waits until a connection is initiated by the client software 110. When initiating a connection, the client software 110 may transmit additional information such as the resolution of a display device (not shown) coupled to the secondary computer 106. In response to a connection from the client software 110, the server software 108 begins to collect graphics data that was rendered for display on a display device (not shown) coupled to the primary computer 102, compress the graphics data and transmit the compressed graphics data to the client software 110 via the communications link 104. The client software 110 receives compressed graphics data from the server software 108, decompresses the graphics data and displays the decompressed graphics data on the display device coupled to the secondary computer 106. The transmission from the server software 108 to the client software 110 continues until the client software 110 terminates the connection between the server software 108 and the client software 110. In addition, the client software 110 collects inputs, such keyboard key strokes or mouse inputs, at the secondary computer 106 and transmits the inputs to the server software 108. The server software 108 captures the received inputs and causes the inputs to effect the operation of the primary computer 102 or applications executing within the server 102.

The communications link 104 includes a plurality of network communications systems, such as routers and switches, configured to facilitate data communication between the client software 110 and the server software 108. Persons skilled in the art will recognize that many technically feasible techniques exist for building the communications link 104, including technologies practiced in deploying the well-known internet communications network.

The primary computer 102 and the secondary computer 106 may be any type of computing device including, but not limited to, a desktop personal computer (PC), a laptop, a tablet PC, a personal digital assistant (PDA) or a mobile device, such as a mobile phone.

In one embodiment, a plurality of secondary computers, such as the secondary computer 106, can connect to the primary computer 102 simultaneously via corresponding client software.

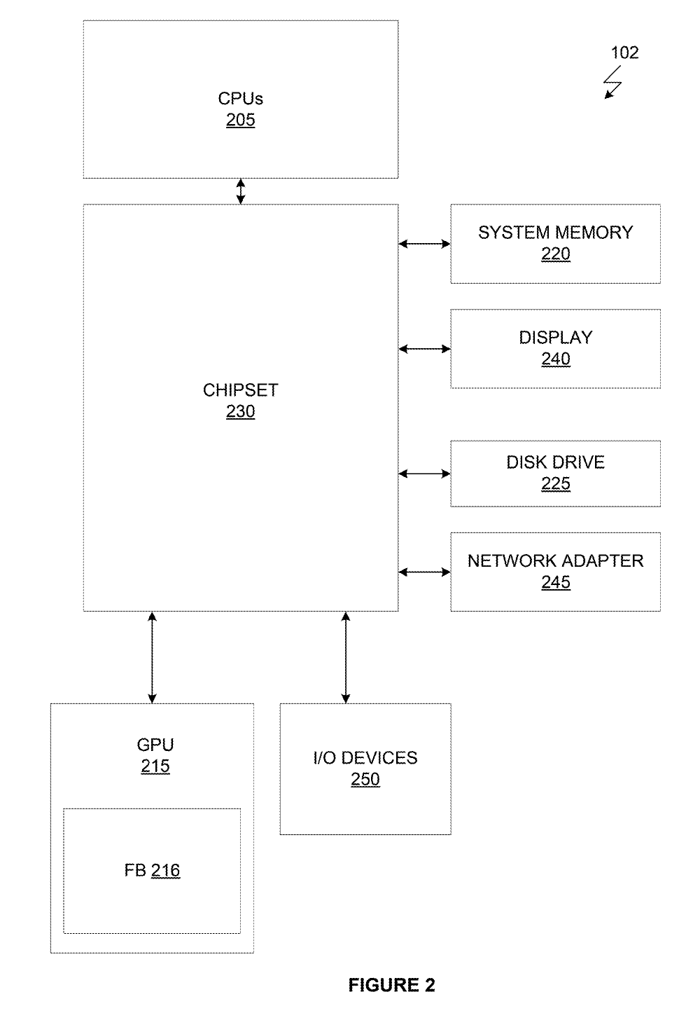

FIG. 2 illustrates a more detailed view of the primary computer 102 of FIG. 1, according to one embodiment of the present invention. As shown, the primary computer 102 includes one or more central processing units (CPUs) 205, a graphics processing unit (GPU) 215, a chipset 230, system memory 220, a disk drive 225, display device 240, network adapter 245 and I/O devices 250 communicatively coupled by one or more busses (not shown). In addition, the GPU 215 includes a frame buffer 216.

The chipset 230 is configured as an input/output hub for communicating data and instructions between the CPU 205, the GPU 215, the system memory 220, the disk drive 225 and the peripheral devices 240, 245 and 250. The peripheral devices 215, 240-265 may include the display device 240, a network adapter (e.g., Ethernet card) 245, CD drive, DVD drive, a keyboard, a pointing device, a speaker, a printer, and/or the like.

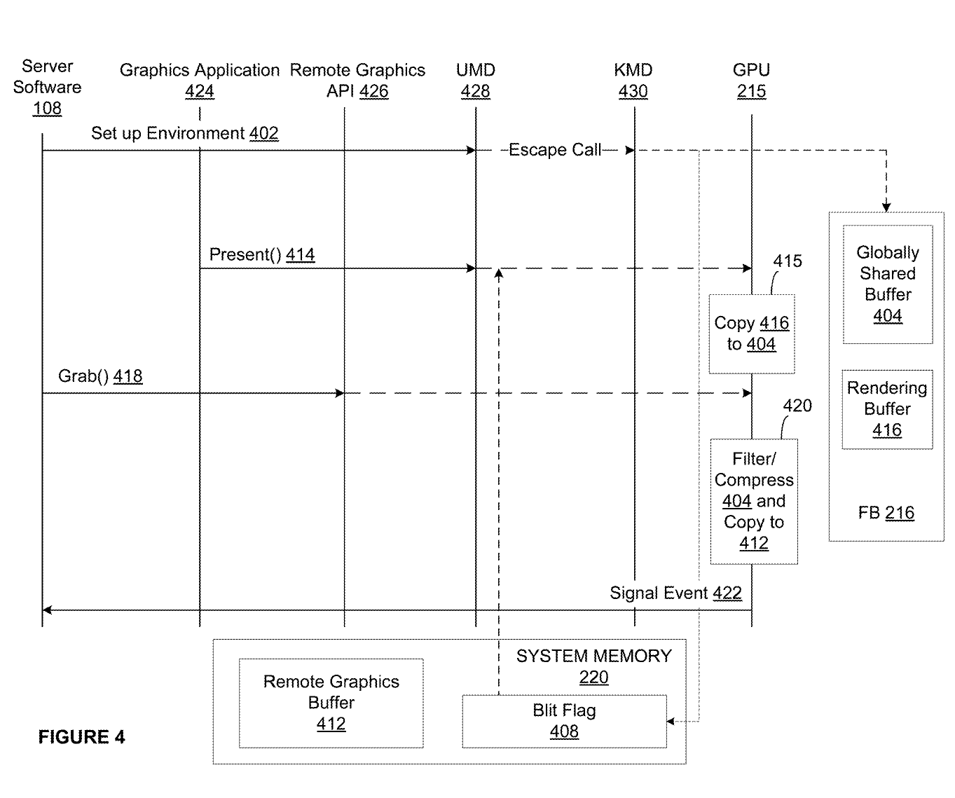

In operation, the server software 108 described above executes on the CPU 205 and collects graphics data related to other applications executing on the CPU 205 and rendered by the GPU 215. The collected graphics data is then compressed and transmitted to the client software 110 over the communications link 104 via the network adapter 245. The operation of the server software 108 with respect to collecting, compressing and transmitting the graphics data is described in greater detail below in conjunction with FIG. 4.

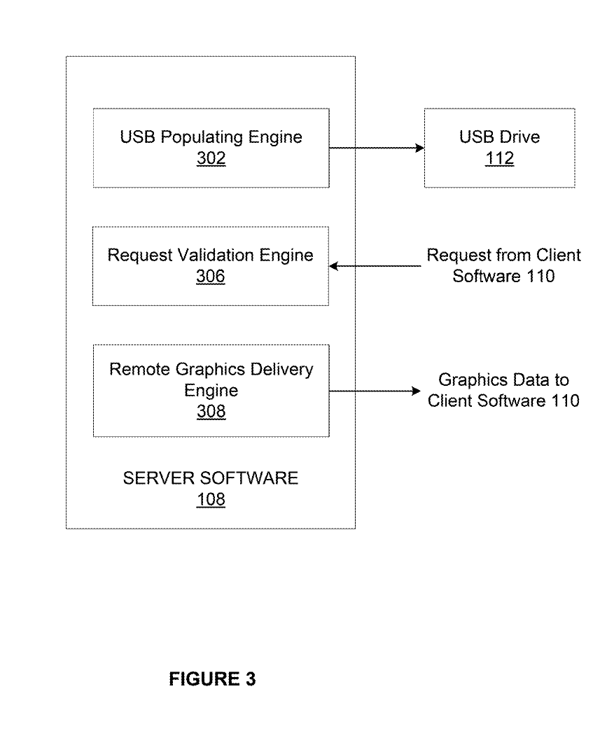

FIG. 3 is a more detailed view of the server software 108 of FIG. 1, according to one embodiment of the present invention. As shown, the server software 108 includes a universal serial bus (USB) populating engine 302 coupled to a USB drive 112, a request validation engine 306 and a remote graphics delivery engine 308.

The USB populating engine 302 populates the USB drive 112 with applications, security information and connection information needed by a secondary computer, such as secondary computer 106, to remotely connect to the primary computer 102. In one embodiment, the USB populating engine 302 is configured to populate any other type of external drive, such as an external hard disk.

In operation, when the USB populating engine 302 receives a request to populate the USB drive 112, the USB populating engine 302 first generates an encryption key that is unique to the USB drive 112. Any technically feasible mechanism for generating an encryption key is within the scope of this invention. The USB populating engine 302 then stores the encryption key in the USB drive 112. Further, the USB populating engine 302 also stores client software 110 configured to connect to the server software 108 and receive graphics data from the server software 108 in the USB drive 112. Finally, the USB populating engine 302 stores connection information that is used by the client software 110 to connect to the server software 108 in the USB drive 112. In one embodiment, the connection information includes a network address, such as the internet protocol (IP) address, of the primary computer 102 and/or firewall information associated with the network on which the primary computer 102 resides.

Once the USB drive 112 is populated, any secondary computer, such as secondary computer 106, that is then coupled to the USB drive 112 is capable of remotely connecting to the primary computer 102 using the client software 110 stored in the USB drive 112. In operation, the remote graphics client software stored in the USB drive 112 is executed on the secondary computer without any configuration or installation operations. Further, when executed, the client software 110 uses the connection information stored in the USB drive 112 to transmit a connection request to the server software 108 on the primary computer 102. The connection request includes the encryption key stored in the USB drive 112.

The request transmitted to the primary computer 102 is validated by the request validation engine 306. The request validation engine 306 determines whether the encryption key included in the request is valid (i.e., whether the encryption key is an encryption key that was generated by the USB populating engine 302). Any technically feasible mechanism for validating an encryption key is within the scope of this invention. If, the encryption key included in the request is not valid, then the request validation engine 306 transmits an error to the client software 110. If, however, the encryption key included in the request is valid, then the request validation engine 306 indicates to the remote graphics delivery engine 308 that the client software 110 is permitted to receive graphics data. The remote graphics delivery engine 308 then enables the transmission of graphics data to the client software 110. The technique for transmitting graphics data to the client software 110 is described in detail below in conjunction with FIG. 4.

In one embodiment, the USB populating engine 302 executes on a different computing device than the request validation engine 304 and the remote graphics delivery engine 308 (which execute on the primary computer 102). In such an embodiment, the USB drive 112 is connected to the computing device that executes the USB populating engine 302 and is populated with the client software 110 and connection information. The connection information included in the USB drive 112 is associated with the primary computer 102. The USB drive 112 is then connected to the secondary computer 106, which executes the client software 110 on the USB drive 112. The client software 110 then connects to the server software 108 executing on the primary computer 102 in the same manner as discussed above.

FIG. 4 illustrates a technique that enables the transmission of rendered graphics data to the client software 110, according to one embodiment of the invention. The technique has three distinct portions. First, setting up a shared buffer to collect rendered graphics data for transmission to the client software 110. Step 402 is directed to the first portion. Second, configuring the GPU 215 to store rendered graphics data in the shared buffer. Steps 414-415 are directed to the second portion. Third, grabbing the rendered graphics data from the shared buffer for transmission to the client software 110. Steps 418-422 are directed to the third portion.

When a connection between the client software 110 and the server software 108 is established, the remote graphics delivery engine 308, at step 402, transmits a request to the remote graphics API 426 to set up the environment for transmitting rendered graphics data from the shared buffer for transmission to the client software 110. The remote graphics API 426 transmits the request to the instance of a device user mode driver (UMD) 428 associated with the server software 108. In response, the device UMD 428 performs two operations.

First, the device UMD 428 allocates the remote graphics buffer 412 in the system memory 220 for storing the graphics data to be transmitted to the client software 110. The remote graphics buffer 412 is configured such that a direct memory access operation can be performed by the GPU 215 to transfer data between the frame buffer 216 and the remote graphics buffer 412. Second, the device UMD 428 transmits an escape call to a kernel mode driver (KMD) 430. In response to the escape call, the KMD 430 initializes the globally shared buffer 406 within the frame buffer 216. The globally shared buffer 404 is associated with the server software 108. Also in response to the escape call, the KMD 430 sets the blit flag 408 within the system memory 220 to valid. Each graphics application executing within the primary computer 102, such as graphics application 424, can access the blit flag 408 via the instance of the device UMD 428 associated with the graphics application. When set, the blit flag 408 indicates to the graphics applications that the server software 108 is collecting rendered graphics data for transmission to the client software 110.

At step 414, the graphics application 424 transmits a graphics command stream that includes a present ( ) call to the instance of the device UMD 428 associated with the graphics application 424 for transmission to the GPU 215. The graphics command stream includes one or more commands for rendering graphics data associated with the graphics application 424. The present( ) call that, when processed, causes the rendered graphics data associated with the graphics application 424 to be displayed on the display device 240.

When the graphics command stream includes a present( ) call, the device UMD 428 determines whether graphics data is being collected for transmission to the client software 110. To make such a determination, the device UMD 428 accesses the blit flag 408 to determine if the blit flag 408 is set. Again, when set, the blit flag 408 indicates that the server software 108 is collecting rendered graphics data for transmission to the client software 110. If the device UMD 428 determines that graphics data is being collected for transmission to the client software 110, then the device UMD 428 inserts commands into the graphics command stream that cause the GPU 215 to copy any rendered graphics data generated as a result of the command stream to the globally shared buffer 404 that was initialized by the server software 108 at step 402.

The GPU 215, in response to receiving the graphics command stream, renders the graphics data and stores the rendered graphics data in the cascading buffer 416 included in the frame buffer 216. Further, if the device UMD 428 inserted commands to copy the rendered graphics data to the globally shared buffer 404, then the GPU 215, at step 415, copies the rendered graphics data from the cascading buffer 416 to the globally shared buffer 404 via a blit operation.

At step 418, the remote graphics delivery engine 308 transmits a request to the remote graphics API 426 to “grab” the rendered graphics data stored in the globally shared buffer 404. The remote graphics API 426, via the device UMD 428, transmits commands to the GPU 215, that, when executed by the GPU 215, causes the GPU 215, at step 420, to perform one or more scaling, filtering or pixel shading operations, such as compression, on the graphics data stored in the globally shared buffer 404. The operations may include scaling the graphics data based on a resolution associated with the secondary computer 106 that was received when the remote graphics connection between the client software 110 and the server software 108 was established. The operations may also include applying a pixel shader to the graphics data to preserve the quality of the graphics data while scaling. Any other technically feasible graphics operation can be performed on the graphics data stored in the globally shared buffer 404.

The resulting graphics data is copied by the GPU 215 to the remote graphics buffer 412 via a direct memory access (DMA) operation. As previously described herein, the remote graphics buffer 402 is configured such that the GPU 215 can directly transfer data to the remote graphics buffer 412 from the frame buffer 216. In one embodiment, the graphics data resulting from the filtering/scaling/shading operations is stored in a temporary buffer before being copied to the remote graphics buffer 412. At step 422, when the GPU 215 completes the DMA operation, the GPU 215 raises an event that is transmitted to the remote graphics delivery engine 308 and indicates that the DMA operation is complete.

The remote graphics delivery engine 308 can then optionally perform compression operations on the graphics data stored in the remote graphics buffer 402. The graphics data is then transmitted to the client software 110 via the communications link 104. The client software 110 decompresses the graphics data, and the decompressed graphics data is displayed on a display device (not shown) coupled to the secondary computer 106.

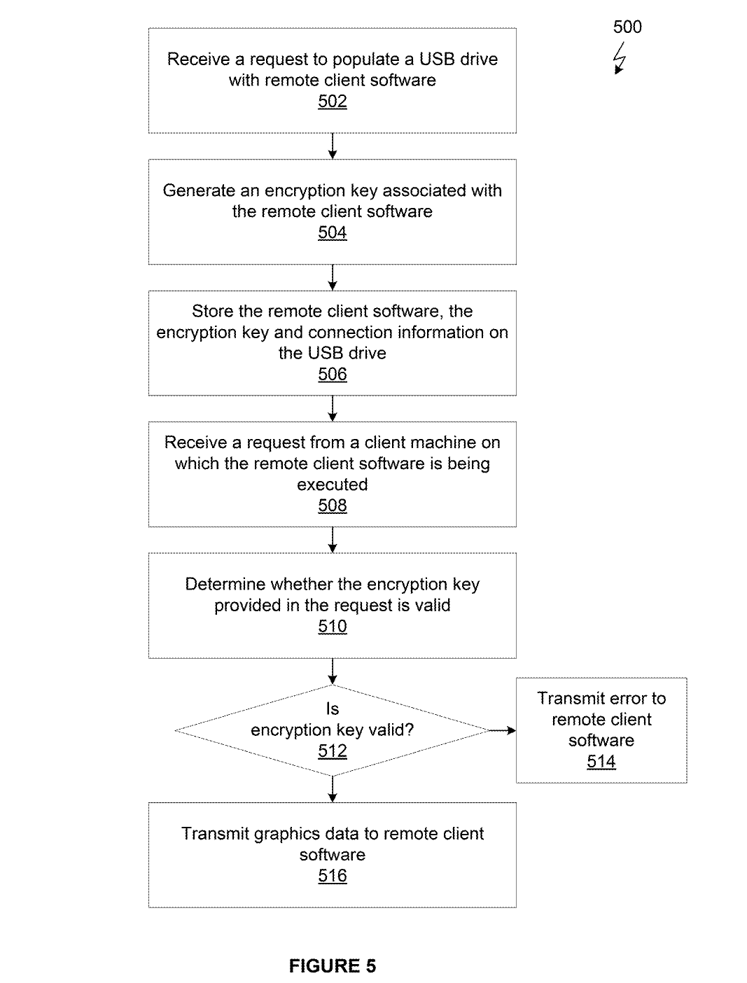

FIG. 5 is forth a flow diagram of method steps for enabling a client machine to connect to the remote server using data stored on a USB drive, according to one embodiment of the invention. Although the method steps are described in conjunction with the systems for FIGS. 1-4, persons skilled in the art will understand that any system configured to perform the method steps, in any order, is within the scope of the invention.

The method 500 beings at step 502, where the USB populating engine 302 receives a request to populate the USB drive 112. The request may be transmitted to the USB populating engine 302 by a user of the server software 108 or automatically when the USB drive 112 is connected to the primary computer 102. At step 504, the USB populating engine 302 generates an encryption key that is unique to the USB drive 112. At step 506, the USB populating engine 302 stores in the USB drive 112 the encryption key generated at step 504, client software 110 and connection information that is used by the client software 110 to connect to the server software 108. As discussed above, once the USB drive 112 is populated, the secondary computer 106 that is then connected to the USB drive 112 is capable of remotely connecting to the primary computer 102 using the client software 110 stored in the USB drive 112. In operation, client software 110 stored in the USB drive 112 is executed on the secondary computer 106 without any configuration or installation operations.

At step 508, the request validation engine 306 receives a connection request from the client software 110 executing on the secondary computer 106. The client software 110 uses the connection information stored in the USB drive 112 to transmit the connection request to the request validation engine 306. At step 510, the request validation engine 306 determines whether the encryption key included in the request is valid, i.e., is an encryption key that was generated by the USB populating engine 302. If, the encryption key included in the request is not valid, then the method 500 proceeds to step 514, where request validation engine 306 transmits an error to the client software 110. If, however, the encryption key included in the request is valid, then the method 500 proceeds to step 516. At step 516, the remote graphics delivery engine 308 then enables the transmission of graphics data to the client software 110. The technique for transmitting graphics data to the client software 110 is described in detail above in conjunction with FIG. 4.

Advantageously, the remote graphics client software stored on the external storage device executes directly on the remote computer without any installation and configuration operations. Therefore, the remote graphics client software is able to connect to a server process efficiently and quickly without requiring any manual user operations. Further, the user experience when connecting to the primary computer from a secondary computer is greatly improved because the user does not have to perform any cumbersome operations to begin receiving remotely rendered graphics on the secondary computer.

One embodiment of the invention may be implemented as a program product for use with a computer system. The program(s) of the program product define functions of the embodiments (including the methods described herein) and can be contained on a variety of computer-readable storage media. Illustrative computer-readable storage media include, but are not limited to: (i) non-writable storage media (e.g., read-only memory devices within a computer such as CD-ROM disks readable by a CD-ROM drive, flash memory, ROM chips or any type of solid-state non-volatile semiconductor memory) on which information is permanently stored; and (ii) writable storage media (e.g., floppy disks within a diskette drive or hard-disk drive or any type of solid-state random-access semiconductor memory) on which alterable information is stored. Another embodiment of the invention may be implemented as a program product deployed for use over a network. In such an embodiment, the program product may be accessed via a web browser.

The invention has been described above with reference to specific embodiments. Persons skilled in the art, however, will understand that various modifications and changes may be made thereto without departing from the broader spirit and scope of the invention as set forth in the appended claims. The foregoing description and drawings are, accordingly, to be regarded in an illustrative rather than a restrictive sense.

We claim:

1. A computer-implemented method for enabling a remote computer to receive graphics data from a primary computer, the method comprising:
populating an external storage device with remote graphics client software;
receiving a connection request from the remote graphics client software when the remote graphics client software is executing on a secondary computing device that is coupled to the external storage device; and
in response to the connection request, transmitting locally rendered graphics data to the secondary computing device.

2. The method of claim 1, further comprising populating the external storage device with connection information.

3. The method of claim 2, wherein the connecting request is based on the connection information stored in the external storage device.

4. The method of claim 1, further comprising generating an encryption key associated with the remote graphics client software.

5. The method of claim 4, further comprising populating the external storage device with the encryption key.

6. The method of claim 5, wherein the connection request includes the encryption key.

7. The method of claim 6, further comprising, in response to the connection request, determining that the encryption key is valid.

8. The method of claim 1, wherein the locally rendered graphics data comprises compressed graphics data, and the remote graphics client software, when executing on the secondary computing device, is configured to decompress the compressed graphics data.

9. The method of claim 1, wherein the remote graphics client software is not installed on the secondary computing device.

10. The method of claim 1, wherein locally rendered graphics data transmitted to the secondary computing device is displayed on a display device coupled to the secondary computing device.

11. A computer-readable medium for storing instructions that, when executed by a processor, cause the processor to enabling a remote computer to receive graphics data from a primary computer, by performing the steps of:
populating an external storage device with remote graphics client software;
receiving a connection request from the remote graphics client software when the remote graphics client software is executing on a secondary computing device that is coupled to the external storage device; and
in response to the connection request, transmitting locally rendered graphics data to the secondary computing device.

12. The computer-readable medium of claim 11, further comprising populating the external storage device with connection information.

13. The computer-readable medium of claim 12, wherein the connecting request is based on the connection information stored in the external storage device.

14. The computer-readable medium of claim 11, further comprising generating an encryption key associated with the remote graphics client software.

15. The computer-readable medium of claim 14, further comprising populating the external storage device with the encryption key.

16. The computer-readable medium of claim 15, wherein the connection request includes the encryption key.

17. The computer-readable medium of claim 16, further comprising, in response to the connection request, determining that the encryption key is valid.

18. The computer-readable medium of claim 11, wherein the locally rendered graphics data comprises compressed graphics data, and the remote graphics client software, when executing on the secondary computing device, is configured to decompress the compressed graphics data.

19. The computer-readable medium of claim 11, wherein locally rendered graphics data transmitted to the secondary computing device is displayed on a display device coupled to the secondary computing device.

20. A computing device, comprising:
a memory; and
a processor configured to execute instructions included in the memory and perform the steps of:
populating an external storage device with remote graphics client software,
receiving a connection request from the remote graphics client software when the remote graphics client software is executing on a secondary computing device that is coupled to the external storage device, and
in response to the connection request, transmitting locally rendered graphics data to the secondary computing device.
